(19) United States
(12) Patent Application Publication
(10) Pub. No.: US 2017/0187064 A1
(43) Pub. Date: Jun. 29, 2017

(54) LITHIUM ION SECONDARY BATTERY

(71) Applicant: NEC Energy Devices, Ltd., Sagamihara-shi, Kanagawa (JP)

(72) Inventors: Kouzou TAKEDA, Kanagawa (JP); Yasutaka KONO, Kanagawa (JP); Hiroo TAKAHASHI, Kanagawa (JP); Takayuki SUZUKI, Kanagawa (JP)

(73) Assignee: NEC Energy Devices, Ltd., Sagamihara-shi, Kanagawa (JP)

(21) Appl. No.: 15/129,609

(22) PCT Filed: Mar. 30, 2015
(86) PCT No.: PCT/JP2015/059842

§ 371 Date: Sep. 27, 2016

(30) Foreign Application Priority Data
Mar. 31, 2014 (JP) 2014-073711

(51) Int. Cl. H01M 10/0525; H01M 4/587; H01M 4/36; H01M 4/505; H01M 4/131; H01M 4/133

(52) U.S. Cl. CPC H01M 10/0525; H01M 4/131; H01M 4/133; H01M 4/366; H01M 4/505; H01M 4/587; H01M 2004/021

(57) ABSTRACT

A lithium ion secondary battery including: a positive electrode including a positive electrode active material capable of intercalating and deintercalating a lithium ion; a negative electrode including a negative electrode active material capable of intercalating and deintercalating a lithium ion; and a non-aqueous electrolytic solution, wherein the positive electrode active material includes a Mn-based spinel-type composite oxide and an additional active material, and the content of the Mn-based spinel-type composite oxide based on the whole of the positive electrode active material is 60% by mass or less, and the negative electrode active material includes a first graphite particle containing natural graphite and a second graphite particle containing artificial graphite, and the content of the second graphite particle based on the sum total of the first graphite particle and the second graphite particle is in the range of 1 to 30% by mass.

### TECHNICAL FIELD

The present invention relates to a lithium ion secondary battery.

### BACKGROUND ART

Lithium ion secondary batteries have high energy density and excellent charge/discharge cycle characteristics, and are thus widely used for a power supply for compact mobile devices such as cellular phones and laptop computers. In addition, the recent increasing environmental considerations and growing consciousness of energy saving have been promoting a demand for large batteries having a large capacity and a long life in the fields of electric vehicles, hybrid electric vehicles, power storage, etc.

In general, a lithium ion secondary battery primarily consists of: a negative electrode including a negative electrode active material of a carbon material capable of intercalating and deintercalating a lithium ion; a positive electrode including a positive electrode active material of a lithium composite oxide capable of intercalating and deintercalating a lithium ion; a separator separating the negative electrode and the positive electrode; and a non-aqueous electrolytic solution prepared by dissolving a lithium salt in a non-aqueous solvent.

Amorphous carbon or graphite is used for the carbon material used as the negative electrode active material, and graphite is typically used particularly in an application which requires a high energy density.

For examples, Patent Literature 1 discloses that in order to obtain a non-aqueous electrolytic solution secondary battery which exhibits a high capacity and a high charge/discharge efficiency, a negative electrode active material is used which includes a carbon material containing at least two materials of a scale-shaped graphite particle and a graphite material the surface of which is covered with amorphous carbon and which is not scale-shaped, the packing density of the negative electrode being in the range of 1.3 to 1.8 g/cc, the specific surface area of the negative electrode being in the range of 2.1 to 4.1 cm²/g, and the fraction of the scale-shaped graphite particle being in the range of 10 to 70% by mass based on the whole of the carbon material.

Patent Literature 2 discloses that in order to obtain a non-aqueous electrolyte battery which has a high capacity and high cycle characteristics and exhibits a high volume energy density even in discharging at a large current, a negative electrode active material is used which includes a negative electrode active material mixture of scale-shaped graphite and at least one or more carbon materials selected from spheroidal graphite, bulk graphite, fibrous graphite, non-graphitizable carbon, and carbon black, the content of the one or more carbon materials in the negative electrode active material mixture being in the range of 1% by mass or more and 50% by mass or less.

Patent Literature 3 discloses that an active material including a mixture of an artificial graphite particle having a tap density of 1 g/cm³ or higher and a spheroidal graphite particle having a large roundness is used for the purpose of significantly improving the charge/discharge cycle characteristics of a high-energy density lithium secondary battery, and simultaneously enhancing or maintaining the discharge rate characteristics, the discharge characteristics at low temperatures, and the heat resistance. Patent Literature 3 also discloses that the fraction of the spheroidal graphite particle based on the whole of the active material is preferably 5 to 45% by mass.

Regarding a positive electrode active material, Patent Literature 4 discloses that a positive electrode active material including a Mn-containing oxide having a particular composition and a spinel structure and a Ni-containing oxide having a particular composition and a layered structure is used in order to obtain a lithium ion secondary battery which allows for rapid charging.

### CITATION LIST

### Patent Literature

Patent Literature 1: JP3152226B

Patent Literature 2: JP2002-008655A

Patent Literature 3: JP2004-127913A

Patent Literature 4: JP2011-076997A

### SUMMARY OF INVENTION

### Technical Problem

However, lithium ion secondary batteries with a positive electrode active material including a Mn-containing oxide having a spinel structure and a graphite-based negative electrode active material have the problem of insufficiently-improved cycle characteristics.

An object of the present invention is to provide a lithium ion secondary battery having improved cycle characteristics.

### Solution to Problem

According to one aspect of the present invention is provided a lithium ion secondary battery including: a positive electrode including a positive electrode active material capable of intercalating and deintercalating a lithium ion; a negative electrode including a negative electrode active material capable of intercalating and deintercalating a lithium ion; and a non-aqueous electrolytic solution, wherein

the positive electrode active material includes a Mn-based spinel-type composite oxide and an additional active material, and the content of the Mn-based spinel-type composite oxide based on the whole of the positive electrode active material is 60% by mass or less, and

the negative electrode active material includes a first graphite particle containing natural graphite and a second graphite particle containing artificial graphite, and the content of the second graphite particle based on the sum total of the first graphite particle and the second graphite particle is in the range of 1 to 30% by mass.

### Advantageous Effect of Invention

According to an exemplary embodiment, a lithium ion secondary battery having improved cycle characteristics can be provided.

### BRIEF DESCRIPTION OF DRAWING

FIG. 1 is a cross-sectional view for describing an example of a lithium ion secondary battery according to an exemplary embodiment.

### DESCRIPTION OF EMBODIMENT

Hereinafter, an exemplary embodiment will be described.

A lithium ion secondary battery according to an exemplary embodiment includes: a positive electrode including a positive electrode active material capable of intercalating and deintercalating a lithium ion; a negative electrode including a negative electrode active material capable of intercalating and deintercalating a lithium ion; and a non-aqueous electrolytic solution, and the positive electrode active material includes a Mn-based spinel-type composite oxide, and the negative electrode active material includes a first graphite particle containing natural graphite and a second graphite particle containing artificial graphite. The content of the Mn-based spinel-type composite oxide based on the whole of the positive electrode active material in the positive electrode of the secondary battery is 60% by mass or less, and the content of the second graphite particle based on the sum total of the first graphite particle and the second graphite particle in the negative electrode is in the range of 1 to 30% by mass.

Use of a Mn-based spinel-type composite oxide for the positive electrode active material allows a battery to have a higher stability of a charging state, and enables cost reduction for raw materials. From such a viewpoint, the content of the Mn-based spinel-type composite oxide based on the whole of the positive electrode active material is preferably 8% by mass or more, more preferably 10% by mass or more, and even more preferably 20% by mass or more. On the other hand, from the viewpoint of preventing Mn from eluting into the electrolytic solution, the content of the Mn-based spinel-type composite oxide based on the whole of the positive electrode active material can be set to be 60% by mass or less, and the content is preferably 50% by mass or less, and more preferably 40% by mass or less.

Natural graphite is less expensive than artificial graphite, and has a high degree of graphitization, and thus use of natural graphite as the negative electrode active material enables high-capacity implementation in combination with cost reduction for raw materials. On the other hand, artificial graphite is more expensive than natural graphite; however, it typically contains fewer impurities while having an appropriate degree of graphitization and hardness and also has a low electrical resistance, which is advantageous for improving battery performance such as cycle characteristics. However, the present inventors have found that, in a lithium ion secondary battery with a Mn-based spinel-type composite oxide as a positive electrode active material, a too much content of artificial graphite in the negative electrode tends to degrade the cycle characteristics. From the viewpoint of preventing such degradation of cycle characteristics and simultaneously reducing cost, the content of the second graphite particle (artificial graphite) based on the sum total of the first graphite particle containing natural graphite and the second graphite particle containing artificial graphite can be set to be 30% by mass or less, and the content is preferably 20% by mass or less, and more preferably less than 10% by mass. From the viewpoint of obtaining an advantageous effect of addition of artificial graphite, the content of the second graphite particle (artificial graphite) can be set to be 1% by mass or more, and the content is preferably 2% by mass or more, and more preferably 4% by mass or more.

In addition, setting the particle shape, particle size distribution, and median particle diameter of each of the first graphite particle and the second graphite particle, as described below, provides much better battery performance, particularly good cycle characteristics.

The first graphite particle (natural graphite particle) preferably includes a spheroidized particle, and the second graphite particle (artificial graphite particle) preferably includes a particle having an average particle roundness lower than that of the first graphite particle. For the first graphite particle, a spheroidized particle having an average particle roundness in the range of 0.6 to 1 can be used. For the second graphite particle, a scale-shaped particle can be used.

The ratio of a median particle diameter (D₅₀) to a particle diameter at 5 cumulative % (D₅), D₅₀/D₅, in a cumulative distribution of the first graphite particle is preferably smaller than the ratio of a median particle diameter (D₅₀) to a particle diameter at 5 cumulative % (D₅), D₅₀/D₅, in a cumulative distribution of the second graphite particle. Then, D₅₀/D₅ of the first graphite particle is preferably 1.5 or smaller, and more preferably 1.36 or smaller, and D₅₀/D₅ of the second graphite particle is preferably larger than 1.5, and more preferably larger than 1.52. In addition, the median particle diameter (D₅₀) of the first graphite particle is preferably in the range of 10 to 20 μm, and the median particle diameter (D₅₀) of the second graphite particle is preferably in the range of 5 to 30 μm.

Now, the lithium ion secondary battery according to an exemplary embodiment will be described specifically.

### (Negative Electrode)

A negative electrode which can be suitably used for the lithium ion secondary battery according to an exemplary embodiment is, for example, a negative electrode in which a negative electrode active material layer including a binder and the negative electrode active material including the first graphite particle and the second graphite particle is provided on a negative electrode current collector.

The first graphite particle contains natural graphite, and commonly available natural graphite materials may be used for the first graphite particle. The first graphite particle is preferably a spheroidized particle (not scale-shaped), and the average particle roundness is preferably in the range of 0.6 to 1, more preferably 0.86 to 1, even more preferably 0.90 to 1, and particularly preferably 0.93 to 1. Spheroidization may be performed by using a conventional method.

The second graphite particle contains artificial graphite, and commonly available artificial graphite materials may be used for the second graphite particle. Examples thereof include an artificial graphite obtained by heat-treating a graphitizable carbon such as coke (e.g., petroleum coke, coal coke) and pitch (e.g., coal pitch, petroleum pitch, coal tar pitch) for graphitization at a temperature of 2000 to 3000° C., preferably at a high temperature of 2500° C. or higher; an artificial graphite obtained by graphitizing two or more graphitizable carbons; and an artificial graphite obtained by heat-treating a graphitizable carbon consisting of petroleum coke or coal coke for graphitization at a high temperature of 2500° C. or higher. In terms of shape, the average particle roundness of the second graphite particle is preferably smaller than the average particle roundness of the first graphite particle, and preferably lower than 0.86, more preferably 0.85 or lower, and even more preferably 0.80 or lower. For example, an artificial graphite particle having an average particle roundness of 0.5 or higher and lower than 0.86, or an artificial graphite particle having an average particle roundness in the range of 0.6 to 0.85 may be used. For example, a scale-shaped particle may be used.

The particle roundness is given as follows: a particle image is projected on a plane; and when designating the periphery length of a corresponding circle having the same area as the projected particle image as l and designating the periphery length of the projected particle image as L, the ratio l/L is defined as the particle roundness.

An average particle roundness can be measured with a commercially available electron microscope as follows. In an exemplary embodiment and Examples described later, the measurement was performed with a scanning electron microscope manufactured by Hitachi, Ltd. (trade name: S-2500) as follows: first, an image of a graphite particle (powder) was observed with the electron microscope at a magnification of 1000×, the image was projected on a plane, and the periphery length of the projected image, L, was determined; the periphery length of a corresponding circle having the same area as the projected image of the particle observed, l, was then determined; the ratio of the periphery length l to the periphery length of the projected image of the particle, L, i.e., l/L, was calculated for arbitrarily selected 50 particles; and the average value was used as the average particle roundness. Alternatively, this measurement can be performed with a flow-type particle image analyzer. For example, it have been confirmed that almost the same value was obtained even when the particle roundness was measured with a powder measurement apparatus available from Hosokawa Micron Corporation (trade name: FPIA-1000).

The content of the second graphite particle based on the sum of the first graphite particle and the second graphite particle is set in the range of 1 to 30% by mass, as described above, and the content is preferably 20% by mass or less, and more preferably less than 10% by mass, and preferably 2% by mass or more, and more preferably 4% by mass or more.

Addition of artificial graphite can contribute to preventing the particle from being crashed or excessively deformed (in particular, near the surface) when being pressed in fabrication of an electrode due to the fact that an artificial graphite particle is generally harder than a natural graphite particle, and can contribute to homogeneous transmission of a force in the thickness direction of an electrode, resulting in contribution to a homogeneous density distribution in the thickness direction. An electrode having a homogeneous density distribution, in which the particles contact with each other while keeping a moderate number of voids, is good in permeability and retention capacity for an electrolytic solution and electroconductivity, and can contribute to enhancement of battery characteristics such as cycle characteristics. In addition, a pressing pressure can be homogeneously transmitted in an electrode, which suppresses thickening of the electrode (spring back) due to a residual stress after pressing, and as a result the reduction of the capacity of the electrode can also be suppressed. Moreover, artificial graphite has fewer impurities attached to the surface than natural graphite, and thus a SEI (solid electrolyte interphase) film with a high quality tends to be formed. Owing to this, intercalation of a lithium ion occurs more preferentially at an artificial graphite particle than at a natural graphite particle, and as a result the cycle degradation of the natural graphite particle can be suppressed.

The ratio of a median particle diameter (D₅₀) to a particle diameter at 5 cumulative % (D₅) , D₅₀/D₅, in a cumulative distribution of the first graphite particle is preferably smaller than the ratio of a median particle diameter (D₅₀) to a particle diameter at 5 cumulative % (D₅), D₅₀/D₅, in a cumulative distribution of the second graphite particle. Then, D₅₀/D₅ of the first graphite particle is preferably 1.5 or smaller, and more preferably 1.36 or smaller. D₅₀/D₅ of the second graphite particle is preferably larger than 1.5, and more preferably larger than 1.52. Thus, the particle diameter distribution of the second graphite particle is broader than the particle diameter distribution of the first graphite particle, which allows the first graphite particle and the second graphite particle to contact with each other at many contact points, and as a result can suppress the increase of resistance in cycles to contribute to prevention of the occurrence of capacity reduction. Here, a particle diameter D₅ refers to a particle diameter at an integrated value up to 5% in a particle size distribution (volume-based) obtained by using a laser diffraction/scattering method, and a particle diameter D₅₀ refers to a particle diameter at an integrated value up to 50% in a particle size distribution (volume-based) obtained by using a laser diffraction/scattering method.

The tap density in saturation of the particle mixture of the first graphite particle and the second graphite particle is, from the viewpoint of fabricating a negative electrode having a high density with the damage of the particle reduced during pressing in electrode fabrication, preferably higher than both the tap density in saturation of the first graphite particle and the tap density in saturation of the second graphite particle, and more preferably 1.1 g/cm³ or higher, and, for example, can be set in the range of 1.1 to 1.30 g/cm³ and in the range of 1.1 to 1.25 g/cm³. Then, the tap density in saturation of the first graphite particle to be used is preferably higher than 0.8 g/cm³, and more preferably 0.9 g/cm³ or higher, and it can be lower than 1.25 g/cm³, particularly 1.20 g/cm³ or lower. The tap density in saturation of the second graphite particle to be used is preferably higher than 0.8 g/cm³, and it can be lower than 1.10 g/cm³, particularly 1.00 g/cm³ or lower.

Tap density in saturation can be measured with a commercially available measuring instrument as follows. In an exemplary embodiment and Examples described later, the measurement was performed with a measuring instrument manufactured by Seishin Enterprise Co., Ltd. (trade name: Tap Denser KYT-3000) as follows: first, approximately 40 cc (40 cm³) of a graphite powder was placed in a tapping cell having a volume of 45 cc (45 cm³), which was then tapped 1000 times, and thereafter the tap density was calculated by using the following formula:

tap density in saturation [g/cm³]=(B−A)/D

wherein, A: mass of tapping cell, B: total mass of tapping cell and graphite powder, and D: filling volume.

If the above particle size distribution conditions are satisfied, the tap density in saturation of the particle mixture of the first graphite particle and the second graphite particle can be higher than the tap density in saturation of each of the first graphite particle alone and the second graphite particle alone. A higher tap density in saturation increases the number of contact points between the graphite particles to ensure the electroconductivity, and thus the increase of resistance due to shortage of contact points caused by expansion and shrinkage in battery cycles is suppressed and the capacity is less likely to be degraded. If D₅₀/D₅ of the first graphite particle is smaller than D₅₀/D₅ of the second graphite particle, that is, the second graphite particle which has a relatively broad particle size distribution is added to the first graphite particle which has a sharp particle size distribution at a particular ratio, the packing factor presumably increases, resulting in the increase of the tap density in saturation of the mixture. In this case, it is effective to use a spheroidized graphite particle for the first graphite particle and use the second graphite particle having a roundness lower than that of the first graphite particle for the second graphite particle. A scale-shaped graphite particle may be used for the second graphite particle. Too much content of the second graphite particle having a low roundness causes a large spring back or reduction of the peel strength of an electrode, which makes it difficult to respond to volume change in cycles, and as a result the capacity of the electrode tends to be lowered to degrade the cycle characteristics of the battery.

The average particle diameter of the negative electrode active material including the first graphite particle and the second graphite particle is preferably in the range of 2 to 40 μm, and more preferably in the range of 5 to 30 μm from the viewpoint of, for example, charge/discharge efficiency and input/output characteristics. In particular, the average particle diameter of the first graphite particle in a single configuration is preferably in the range of 10 to 20 μm, and the average particle diameter of the second graphite particle in a single configuration is preferably in the range of 5 to 30 μm. Here, an average particle diameter refers to a particle diameter at an integrated value up to 50% (median diameter: D₅₀) in a particle size distribution (volume-based) obtained by using a laser diffraction/scattering method.

The BET specific surface area (acquired in measurement at 77 K in accordance with a nitrogen adsorption method) of each of the first graphite particle and the second graphite particle is preferably in the range of 0.3 to 10 m²/g, more preferably in the range of 0.5 to 10 m²/g, and even more preferably in the range of 0.5 to 7.0 m²/g from the viewpoint of charge/discharge efficiency and input/output characteristics.

Use of a spheroidized particle (non-scale-shaped particle) for the first graphite particle and a particle having a roundness lower than that of the first graphite particle (e.g., a scale-shaped particle) for the second graphite particle with the above mixing ratio, particle size distribution, tap density in saturation, particle diameter or the like controlled allow the second graphite particle to be buried between the first graphite particles in a homogeneously dispersed manner, and the first graphite particle and the second graphite particle can be packed in a high density. As a result, an adequate number of contact points are formed between the particles while the electrolytic solution sufficiently permeates, and thus the increase of resistance in cycles is suppressed and the capacity is less likely to be lowered.

The first graphite particle may be covered with amorphous carbon. Also, the second graphite particle may be covered with amorphous carbon. The surface of a graphite particle can be covered with amorphous carbon by using a conventional method. Examples of the method which can be used include a method in which the surface of a graphite particle is attached with an organic substance such as tar pitch and heat-treated; and a film-forming method such as a chemical vapor deposition method (CVD method) and sputtering method (e.g., ion beam sputtering method) with an organic substance such as a condensed hydrocarbon of benzene, xylene or the like, a vacuum deposition method, a plasma method, and an ion plating method. The second graphite particle may be also covered with amorphous carbon. Amorphous carbon covering a graphite particle can inhibit the side reaction between the graphite particle and the electrolytic solution to enhance the charge/discharge efficiency and increase the reaction capacity, and in addition allows the graphite particle to have a higher hardness.

The first graphite particle and the second graphite particle may be mixed together by using a known mixing method. An additional active material may be mixed therein, as necessary, within a range which does not impair a desired effect. The total content of the first graphite particle and the second graphite particle based on the whole of the negative electrode active material is preferably 90% by mass or more, and more preferably 95% by mass or more. The negative electrode active material may be composed only of the first graphite particle and the second graphite particle.

The negative electrode may be formed by using a common slurry application method. For example, a slurry containing a negative electrode active material, a binder, and a solvent is prepared, and the slurry is applied on a negative electrode current collector, dried, and pressurized, as necessary, to obtain a negative electrode in which a negative electrode active material layer is provided on the negative electrode current collector. Examples of the method for applying a negative electrode slurry include a doctor blade method, die coater method, and a dip coating method. Alternatively, a negative electrode can be obtained by forming a thin film of aluminum, nickel, or an alloy of them as a current collector on a negative electrode active material layer which has been formed in advance, in accordance with a vapor deposition method, a sputtering method, or the like.

The binder for a negative electrode is not limited, and examples thereof include polyvinylidene fluoride (PVdF), vinylidene fluoride-hexafluoropropylene copolymers, vinylidene fluoride-tetrafluoroethylene copolymers, styrene-butadiene copolymer rubbers, polytetrafluoroethylene, polypropylene, polyethylene, polyimide, polyamideimide, methyl (meth)acrylate, ethyl (meth)acrylate, butyl (meth)acrylate, (meth)acrylonitrile, isoprene rubbers, butadiene rubbers, and fluororubbers. For the slurry solvent, N-methyl-2-pyrrolidone (NMP) or water may be used. In the case that water is used for the solvent, a thickener may be further used, such as carboxymethylcellulose, methylcellulose, hydroxymethylcellulose, ethylcellulose, and polyvinyl alcohol.

The content of the binder for a negative electrode is preferably in the range of 0.1 to 30 parts by mass, more preferably 0.5 to 25 parts by mass, and more preferably in the range of 1 to 20 parts by mass based on 100 parts by mass of the negative electrode active material from the viewpoint of binding strength and energy density, which are in a trade-off relation.

The negative electrode current collector is not limited, but preferably copper, nickel, stainless steel, molybdenum, tungsten, tantalum, or an alloy containing two or more of them from the viewpoint of electrochemical stability. Examples of the shape include a foil, a plate, and a mesh.

### (Positive Electrode)

For a positive electrode suitable for the lithium ion secondary battery according to an exemplary embodiment, a positive electrode in which a positive electrode active material layer including a binder and the above-described positive electrode active material including a Mn-based spinel-type composite oxide is provided on a positive electrode current collector can be used.

For the positive electrode active material, a positive electrode active material in which the content of the Mn-based spinel-type composite oxide based on the whole of the positive electrode active material is 60% by mass or less can be used, as described above. The content of the Mn-based spinel-type composite oxide based on the whole of the positive electrode active material is preferably 8% by mass or more, more preferably 10% by mass or more, and even more preferably 20% by mass or more from the viewpoint of, for example, the stability of a charging state of a battery and cost for raw materials. From the viewpoint of preventing Mn from eluting into the electrolytic solution, the content of the Mn-based spinel-type composite oxide based on the whole of the positive electrode active material is set to be 60% by mass or less, and the content is preferably 50% by mass or less, and more preferably 40% by mass or less.

For the Mn-based spinel-type composite oxide, a composition represented by LiMn₂O₄ or a composition represented by LiₐMₓMn₂₋ₓO₄, which is obtained by substituting a part of Mn in the composition formula LiMn₂O₄ with another metal element M, can be used.

Examples of the metal element M include Li, Be, B, Na, Mg, Al, Si, K, Ca, Ti, V, Cr, Fe, Co, Ni, Cu, Zn, Ge, Nb, Ba, and W, and two or more thereof may be used. For example, at least one selected from Li, B, Mg, Al, V, Cr, Fe, Co, Ni, and W may be contained. For another example, at least one selected from Li, B, Mg, Al, Fe, Co, and Ni may be contained.

The composition ratio of the metal element M, x, can be set in the range of 0<x≦1.5, and is preferably in the range of 0.01 to 1.2, and, for example, may be set in the range of 0.01 to 0.3.

The composition ratio of Li, a, is in the range of 0 to 1, which indicates that Li can be eliminated or inserted within the range.

A part of the oxygen atoms O in the composition formula LiₐMₓMn₂₋ₓO₄ may be substituted with another element Z such as F and Cl. In LiₐMₓMn₂₋ₓ(O₄₋ₙZ_{w}), w, the composition ratio of Z, is preferably in the range of 0 to 1, more preferably in the range of 0 to 0.5, and even more preferably in the range of 0 to 0.2.

The Mn-based spinel-type composite oxide can be manufactured by using a conventional method. For example, a lithium raw material including a lithium salt such as lithium carbonate and lithium hydroxide, a Mn raw material including a manganese oxide, etc., and another metal raw material, as necessary, are weighed so as to achieve a desired metal element composition ratio, and they are pulverized and mixed with a ball mill or the like. The mixed powder obtained is calcined at a temperature of 500 to 1200° C. in an air or oxygen to thereby obtain a desired active material.

For the additional positive electrode active material other than the Mn-based spinel-type composite oxide, a known positive electrode active material such as a layered rock salt-type oxide such as a lithium composite oxide, and an olivine-type compound such as lithium iron phosphate can be used. Examples of the lithium composite oxide include lithium cobaltate (LiCoO₂); lithium nickelate (LiNiO₂); compounds obtained by substituting at least a part of the cobalt and nickel in these lithium compounds with another metal element such as aluminum, magnesium, titanium, and zinc; cobalt-substituted lithium nickelates obtained by substituting at least a part of the nickel in lithium nickelate with cobalt; and compounds obtained by substituting a part of the nickel in a cobalt-substituted lithium nickelate with another metal element (e.g., at least one of aluminum, magnesium, titanium, zinc, and manganese). One of these lithium composite oxides may be used singly, or two or more thereof may be used in a mixture.

For example, a lithium-nickel composite oxide represented by the composition formula LiₐMₓNi₁₋ₓO₂ and having a layered structure may be used. This lithium-nickel composite oxide is a compound obtained by substituting a part of the Ni in lithium nickelate (LiNiO₂) with another metal element M.

Examples of the metal element M include Li, Co, Mn, Mg, Al, B, Ti, V, and Zn, and two or more thereof may be used. For example, at least one selected from Li, Co, Mn, Mg, Al, Ti, and Zn may be contained. For another example, at least one selected from Li, Co, Mn, Mg, and Al may be contained.

The composition ratio of the metal element M, x, can be set in the range of 0<x<0.7, and is preferably in the range of 0.01 to 0.68, and more preferably in the range of 0.01 to 0.5.

The composition ratio of Li, a, is in the range of 0 to 1, which indicates that Li can be eliminated or inserted within the range.

Lithium nickelate and the lithium-nickel composite oxide can be manufactured by using a conventional method. For example, a lithium raw material including a lithium salt such as lithium carbonate and lithium hydroxide, a nickel raw material including nickel oxide, etc., and another metal raw material, as necessary, are weighed so as to achieve a desired metal element composition ratio, and they are pulverized and mixed with a ball mill or the like. The mixed powder obtained is calcined at a temperature of 500 to 1200° C. in an air or oxygen to thereby obtain a desired active material.

The specific surface area (a BET specific surface area acquired in measurement at 77 K in accordance with a nitrogen adsorption method) of the positive electrode active material is preferably in the range of 0.01 to 10 m²/g, and more preferably in the range of 0.1 to 3 m²/g. A larger specific surface area requires a larger amount of a binder, which is disadvantageous in terms of the capacity density of an electrode, and a too small specific surface area may lower the ion conductivity between the electrolytic solution and the active material.

The average particle diameter of the positive electrode active material is preferably in the range of 0.1 to 50 μm, more preferably 1 to 30 μm, and even more preferably 5 to 25 μ.m from the viewpoint of the reactivity to the electrolytic solution and rate characteristics. Here, an average particle diameter refers to a particle diameter at an integrated value up to 50% (median diameter: D₅₀) in a particle size distribution (volume-based) obtained by using a laser diffraction/scattering method.

The binder for a positive electrode is not limited, and the binders for a negative electrode can be used. Among them, polyvinylidene fluoride is preferred from the viewpoint of versatility and low cost. The content of the binder for a positive electrode is preferably in the range of 1 to 25 parts by mass, more preferably 2 to 20 parts by mass, and even more preferably 2 to 10 parts by mass based on 100 parts by mass of the positive electrode active material from the viewpoint of binding strength and energy density, which are in a trade-off relation. Further, examples of a binder other than polyvinylidene fluoride (PVdF) include vinylidene fluoride-hexafluoropropylene copolymers, vinylidene fluoride-tetrafluoroethylene copolymers, styrene-butadiene copolymer rubbers, polytetrafluoroethylene, polypropylene, polyethylene, polyimide, and polyamideimide. For the slurry solvent used in fabricating the positive electrode, N-methyl-2-pyrrolidone (NMP) may be used.

The positive electrode current collector is not limited, and aluminum, titanium, tantalum, stainless steel (SUS), another valve metal, or an alloy of them may be used from the viewpoint of electrochemical stability. Examples of the shape include a foil, a plate, and a mesh. In particular, an aluminum foil can be suitably used.

The positive electrode may be formed by using a common slurry application method. For example, a slurry containing a positive electrode active material, a binder, and a solvent (and a conductive aid, as necessary) is prepared, and the slurry is applied on a positive electrode current collector, dried, and pressurized, as necessary, to obtain a positive electrode in which a positive electrode active material layer is provided on the positive electrode current collector.

A conductive aid may be added to the positive electrode active material layer for the purpose of lowering the impedance. Examples of the conductive aid include carbonaceous fine particles such as graphite, carbon black, and acetylene black.

### (Lithium Ion Secondary Battery)

The lithium ion secondary battery according to an exemplary embodiment includes the above negative electrode and positive electrode, and an electrolyte.

For the electrolyte, a non-aqueous electrolytic solution in which a lithium salt is dissolved in one or two or more non-aqueous solvents may be used. The non-aqueous solvent is not limited, and example thereof include cyclic carbonates such as ethylene carbonate (EC), propylene carbonate (PC), butylene carbonate (BC), and vinylene carbonate (VC); chain carbonates such as dimethyl carbonate (DMC), diethyl carbonate (DEC), ethyl methyl carbonate (EMC), and dipropyl carbonate (DPC); aliphatic carboxylates such as methyl formate, methyl acetate, and ethyl propionate; γ-lactones such as γ-butyrolactone; chain ethers such as 1,2-ethoxyethane (DEE) and ethoxymethoxyethane (EME); and cyclic ethers such as tetrahydrofuran and 2-methyltetrahydrofuran. Examples of other non-aqueous solvents which can be used include aprotic organic solvents such as dimethyl sulfoxide, 1,3-dioxolane, dioxolane derivatives, formamide, acetamide, dimethylformamide, acetonitrile, propionitrile, nitromethane, ethylmonoglyme, phosphate triesters, trimethoxymethane, sulfolane, methylsulfolane, 1,3-dimethyl-2-imidazolidinone, 3-methyl-2-oxazolidinone, propylene carbonate derivatives, tetrahydrofuran derivatives, ethyl ether, 1,3-propanesultone, anisole, and N-methylpyrrolidone.

The lithium salt to be dissolved in the non-aqueous solvent is not limited, and examples thereof include LiPF₆, LiAsF₆, LiAlCl₄, LiClO₄, LiBF₄, LiSbF₆, LiCF₃SO₃, LiCF₃CO₂, Li(CF₃SO₂)₂, LiN(CF₃SO₂)₂, and lithium bis(oxalate)borate. One of these lithium salts may be used singly, or two or more thereof may be used in combination. Further, a polymer component may be contained as the non-aqueous electrolyte.

A separator may be provided between the positive electrode and the negative electrode. For the separator, a porous film made of a polyolefin such as polypropylene and polyethylene, a fluororesin such as polyvinylidene fluoride, or polyimide, woven fabric, nonwoven fabric, or the like may be used.

Examples of the shape of a battery include a cylinder, a rectangle, a coin type, a button type, and a laminate type. In the case of a laminate type, it is preferred to use a laminate film for an outer package to contain the positive electrode, the separator, the negative electrode, and the electrolyte. This laminate film includes a resin base material, a metal foil layer, and a heat-seal layer (sealant). Examples of the resin base material include polyester and nylon, and examples of the metal foil layer include an aluminum foil, an aluminum alloy foil, and a titanium foil. Examples of the material for the hot-seal layer include thermoplastic polymer materials such as polyethylene, polypropylene, and polyethylene terephthalate. Each of the resin base material layer and the metal foil layer is not limited to a single layer configuration, and may be in two or more layers. From the viewpoint of versatility and cost, an aluminum laminate film is preferred.

The positive electrode, the negative electrode, and the separator disposed therebetween are contained in an outer package container made of a laminate film, etc., and the electrolytic solution is injected therein, followed by sealing the outer package container. A structure in which an electrode group having a plurality of electrode pairs laminated is contained may be employed.

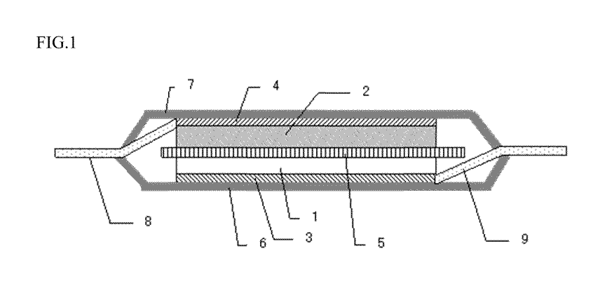

FIG. 1 illustrates a cross-sectional view of an example of the lithium ion secondary battery according to an exemplary embodiment (laminate type). As illustrated in FIG. 1, the lithium ion secondary battery of the present example includes: a positive electrode including a positive electrode current collector 3 made of a metal such as an aluminum foil and a positive electrode active material layer 1 provided thereon and containing a positive electrode active material; and a negative electrode including a negative electrode current collector 4 made of a metal such as a copper foil and a negative electrode active material layer 2 provided thereon and containing a negative electrode active material. The positive electrode and the negative electrode are laminated with a separator 5 made of a nonwoven fabric or a polypropylene microporous membrane interposed therebetween so that the positive electrode active material layer 1 and the negative electrode active material layer 2 are positioned on opposite surfaces of the separator 5. This electrode pair is contained in a container formed of outer packages 6, 7 made of an aluminum laminate film or the like. The positive electrode current collector 3 is connected to a positive electrode tab 9 and the negative electrode current collector 4 is connected to a negative electrode tab 8, and these tabs are extracted through the container to the outside. An electrolytic solution is injected into the container, and the container is sealed. Alternatively, a structure in which an electrode group having a plurality of electrode pairs laminated is contained in a container may be used.

### EXAMPLE

### Example 1

A spheroidized natural graphite particle was provided as graphite A and a scale-shaped artificial graphite was provided as graphite B. As a result of the above-described measurement method, it was confirmed that the average particle roundness of the graphite A was 0.86 or higher and higher than the average particle roundness of the scale-shaped graphite B. In addition, it was confirmed that by using a commercially available laser diffraction/scattering particle size analyzer that D₅₀/D₅ of the graphite A was 1.36 or smaller and D₅₀ of the graphite A was in the range of 10 to 20 μm, and that D₅₀/D₅ of the graphite B was larger than 1.52 and D₅₀ of the graphite B was in the range of 5 to 30 μm. The tap densities in saturation of the graphite A and the graphite B were measured in accordance with the above-described measurement method to be 1.08 g/cm³ and 0.99 g/cm³, respectively. The tap density in saturation of the particle mixture of the graphite A and the graphite B was 1.10 g/cm³.

The graphite A and the graphite B were mixed together at the mass ratio shown in Table 1, and the mixture (negative electrode active material) was mixed with a 1.0 wt % aqueous solution of carboxymethylcellulose to prepare a slurry. A styrene-butadiene copolymer as a binder was mixed therein.

This slurry was applied on one surface of a copper foil having a thickness of 10 μm, and the coating film was dried. Thereafter, the coating film (negative electrode coating film) was roll-pressed so that the density reached 1.5 g/cm³ to obtain a negative electrode sheet having a size of 33×45 mm.

A mixed oxide (positive electrode active material) in which a Mn-based spinel-type composite oxide Li(Li_{0.1}Mn_{1.9})O₄ and a layered rock salt-type oxide LiNi_{0.85}Co_{0.15}O₂ were mixed together at a mass ratio of 30:70 and polyvinylidene fluoride were dispersed in N-methyl-2-pyrrolidone to prepare a slurry. This slurry was applied on both surfaces of an aluminum foil, and the coating films were dried. Thereafter, the coating films (positive electrode coating films) were roll-pressed so that the density reached 3.0 g/cm³ to obtain a positive electrode sheet having a size of 30×40 mm.

The negative electrode sheet was stacked on each surface of the positive electrode sheet with a separator made of a porous polyethylene film having a thickness of 25 μm interposed therebetween so that the positive electrode coating film and the negative electrode coating film were positioned on opposite surfaces of the separator. An extraction electrode for a positive electrode and an extraction electrode for a negative electrode were provided, and then the laminate was covered with a laminate film, into which an electrolytic solution was injected, and the resultant was sealed.

The electrolytic solution used was a solution obtained by dissolving a lithium salt (LiPF₆) in a mixture of ethylene carbonate and diethyl carbonate at a volume ratio of 3:7 so that the concentration of the lithium salt reached 1.0 mol/L.

The lithium ion secondary battery fabricated as described above was subjected to a charge/discharge cycle test (CC-CV charging [CV duration: 1.5 hours], CC discharging, Cycle-Rate: 1C, upper limit voltage: 4.2 V, lower limit voltage: 3.0 V, temperature: 25° C., 45° C.), and the capacity retention rate after 350 cycles was determined. The result is shown in Table 1.

### Comparative Example 1

A lithium ion secondary battery was fabricated in the same manner as in Example 1 except that only natural graphite A was used for the negative electrode active material.

The secondary battery obtained was subjected to a charge/discharge cycle test in the same manner as in Example 1. The result is shown in Table 1.

### Comparative Example 2

A lithium ion secondary battery was fabricated in the same manner as in Example 1 except that only natural graphite A was used for the negative electrode active material and the mass ratio of the Mn-based spinel-type composite oxide (Mn spinel) to the layered rock salt-type oxide in the positive electrode active material was changed to 70:30.

The secondary battery obtained was subjected to a charge/discharge cycle test in the same manner as in Example 1. The result is shown in Table 1.

### Comparative Example 3

A lithium ion secondary battery was fabricated in the same manner as in Example 1 except that the mass ratio of the Mn-based spinel-type composite oxide (spinel oxide) to the layered rock salt-type oxide in the positive electrode active material was changed to 70:30.

The secondary battery obtained was subjected to a charge/discharge cycle test in the same manner as in Example 1. The result is shown in Table 1.

TABLE 1

| | | | | Capacity | Capacity |
|---|---|---|---|---|---|
| | | | | retention rate | retention rate |
| | Content of | Content of | | after 350 | after 350 |
| | natural | artificial | Content of | cycles at | cycles at |
| | graphite A | graphite B | spinel oxide | 45° C. | 25° C. |
| | (% by mass) | (% by mass) | (% by mass) | (%) | (%) |
| Example 1 | 95 | 5 | 30 | 87 | 94 |
| Comparative | 100 | 0 | 30 | 80 | 85 |
| Example 1 | | | | | |
| Comparative | 100 | 0 | 70 | 77 | — |
| Example 2 | | | | | |
| Comparative | 95 | 5 | 70 | 70 | — |
| Example 3 | | | | | |

As can be seen from Table 1, cycle characteristics are improved in the case that the content of the Mn-based spinel-type composite oxide (spinel oxide) in the positive electrode active material is 60% by mass or less and the negative electrode active material contains natural graphite and artificial graphite (the content is in the range of 1 to 30% by mass).

In the foregoing, the present invention has been described with reference to the exemplary embodiments and the Examples; however, the present invention is not limited to the exemplary embodiments and the Examples. Various modifications understandable to those skilled in the art may be made to the constitution and details of the present invention within the scope thereof.

The present application claims the right of priority based on Japanese Patent Application No. 2014-73711 filed on Mar. 31, 2014, the entire disclosure of which is incorporated herein by reference.

### REFERENCE SIGNS LIST

1 positive electrode active material layer
2 negative electrode active material layer
3 positive electrode current collector
4 negative electrode current collector
5 separator
6 laminate outer package
7 laminate outer package
8 negative electrode tab
9 positive electrode tab

1. A lithium ion secondary battery comprising: a positive electrode including a positive electrode active material capable of intercalating and deintercalating a lithium ion; a negative electrode including a negative electrode active material capable of intercalating and deintercalating a lithium ion; and a non-aqueous electrolytic solution, wherein
the positive electrode active material comprises a Mn-based spinel-type composite oxide and an additional active material, and a content of the Mn-based spinel-type composite oxide based on a whole of the positive electrode active material is 60% by mass or less, and
the negative electrode active material comprises a first graphite particle containing natural graphite and a second graphite particle containing artificial graphite, and a content of the second graphite particle based on a sum total of the first graphite particle and the second graphite particle is in a range of 1 to 30% by mass.

2. The lithium ion secondary battery according to claim 1, wherein the content of the second graphite particle based on the sum total of the first graphite particle and the second graphite particle is in a range of 2% by mass or more and less than 10% by mass.

3. The lithium ion secondary battery according to claim 1, wherein the content of the Mn-based spinel-type composite oxide based on the whole of the positive electrode active material is 8% by mass or more.

4. The lithium ion secondary battery according to claim 1, wherein
the first graphite particle comprises a spheroidized particle, and
the second graphite particle comprises a particle having an average particle roundness lower than an average particle roundness of the first graphite particle.

5. The lithium ion secondary battery according to claim 4, wherein the first graphite particle comprises a spheroidized particle having an average particle roundness in a range of 0.6 to 1.

6. The lithium ion secondary battery according to claim 4, wherein the second graphite particle comprises a scale-shaped particle.

7. The lithium ion secondary battery according to claim 1, wherein
a ratio of a median particle diameter (D₅₀) to a particle diameter at 5 cumulative % (D₅), D₅₀/D₅, in a cumulative distribution of the first graphite particle is smaller than a ratio of a median particle diameter (D₅₀) to a particle diameter at 5 cumulative % (D₅), D₅₀/D₅, in a cumulative distribution of the second graphite particle, and
a tap density in saturation of a particle mixture of the first graphite particle and the second graphite particle is higher than both a tap density in saturation of the first graphite particle and a tap density in saturation of the second graphite particle.

8. The lithium ion secondary battery according to claim 7, wherein D₅₀/D₅ of the first graphite particle is 1.5 or smaller.

9. The lithium ion secondary battery according to claim 7, where D₅₀/D₅ of the second graphite particle is larger than 1.5.

10. The lithium ion secondary battery according to claim 1, wherein
a median particle diameter (D₅₀) of the first graphite particle is in a range of 10 to 20 μm, and
a median particle diameter (D₅₀) of the second graphite particle is in a range of 5 to 30 μm.

11. The lithium ion secondary battery according to claim 1, wherein the first graphite particle is covered with amorphous carbon.

12. The lithium ion secondary battery according to claim 1, wherein the positive electrode active material comprises a layered rock salt-type oxide as the additional active material.
